(19) United States
(12) Patent Application Publication
(10) Pub. No.: US 2021/0291386 A1
(43) Pub. Date: Sep. 23, 2021

(54) FOLDING KNIFE

(71) Applicant: Junpei Makari, Kurate-gun (JP)

(72) Inventor: Junpei Makari, Kurate-gun (JP)

(21) Appl. No.: 17/132,236

(22) Filed: Dec. 23, 2020

(30) Foreign Application Priority Data
Nov. 12, 2019 (JP) 2019204706

(51) Int. Cl. B26B 1/04

(52) U.S. Cl. CPC B26B 1/04

(57) ABSTRACT

It is an object of the present invention to provide a folding knife with which, in its open state in which the blade is fully opened from the handle, a protrusion on the blade side can be prevented from hitting the thumb of a user who tries to push the knife down from above with respect to the object to be cut. This is a folding knife comprising a movable piece that is attached to the blade and the handle so as to be relatively rotatable by a specific rotation angle with respect to the blade, and to rotate with respect to the handle together with the blade outside the specific rotation angle; a notch or a recess formed at a position near a rotating shaft portion on the back side of the blade; a protrusion that is formed at a position on the movable piece and in a shape corresponding to the notch or recess of the blade; and a rotation mechanism that allows the movable piece to rotate with respect to the blade only within a specific rotation angle.

### BACKGROUND OF THE INVENTION

### Field of the Invention

The present invention relates to a folding knife in which a blade is opened as a result of a protrusion on the blade side catching on a part of the holster (receptacle) or pocket when the knife is taken out of a specific holster or a garment pocket.

### Description of the Related Art

Folding knives have been known in the past in which the blade is automatically opened from the handle as a result of a protrusion on the blade side of the knife catching on a part of a holster or a pocket when the knife is taken out of a garment pocket or a pouch or other such holster that is attached to a belt.

FIG. 5 is a diagram showing an example of such a knife, and is a revised copy of a part of the drawings given in U.S. Pat. No. 5,878,500. In the knife shown in FIG. 5, a protrusion (numbered 22 and 24 in FIG. 5) is formed on the rear portion near the rotating shaft of the blade (numbered 14 in FIG. 5). This knife is housed in a holster such as a pouch (numbered 32 in FIG. 5) in its closed state in which the blade is disposed inside the handle (numbered 12 in FIG. 5). In the example shown in FIG. 5, when the closed knife is taken out of its holster, the protrusion formed on a part of the blade catches on a part of the holster. As a result of the protrusion catching on a part of the holster, the entire blade on which the protrusion is formed rotates and comes out of the handle, and the blade automatically transitions to its open state in which the blade is fully opened from the handle.

### CITATION LIST

### Patent Literature

Patent Literature 1: U.S. Pat. No. 5,878,500

### SUMMARY OF THE INVENTION

### Problem to be Solved by the Invention

However, with the conventional folding knife shown in FIG. 5, in which a protrusion is formed on a part of the blade so that the protrusion catches on a part of a holster or a pocket and the blade is automatically opened from the handle, when the blade is in its open state in which the blade is fully opened from the handle, the protrusion (numbered 22 and 24 in FIG. 5) is located on the back side of the blade as shown in FIG. 5b. Therefore, when the user tries to cut something such as meat, and the user puts his thumb on the back side of the blade and tries to push the blade down from above, for example (see F in FIG. 5b), the user's thumb hits the protrusion, which is painful, so a problem is that the user cannot push down the back side of the blade with sufficient force.

The present invention was conceived by focusing on this problem encountered with the prior art, and it is an object thereof to provide a folding knife with which, when the closed knife is taken out of a specific holster or a garment pocket, as a result of a protrusion on the blade side catching on a part of the holster or pocket, the blade comes out of the handle and is opened, wherein said folding knife prevents the problem whereby the protrusion on the blade side hits the user's thumb when the user puts his thumb on the back side of the blade and pushes the knife down from above, even when the knife is in its open state in which the blade has been fully opened from the handle.

### Means for Solving Problem

The folding knife according to the present invention for solving the above problem is a folding knife in which a blade and a handle are rotatably connected to each other so as to be able to transition between a closed state, in which the blade is disposed or accommodated in the handle, and an open state, in which the blade is fully open from the handle, and when the closed knife is taken out of a specific holster or a garment pocket, the blade comes out of the handle and is opened as a result of a protrusion on the blade side catching on a part of the holster or pocket, said folding knife comprising a movable piece that is attached to the blade and the handle so as to be relatively rotatable within a specific rotation angle with the blade, and to rotate with respect to the handle together with the blade outside of the specific rotation angle; a notch or a recess formed at a position near a rotating shaft portion on the back side of the blade; a protrusion that is formed at a position on the movable piece and in a shape corresponding to the notch or recess of the blade, said protrusion being capable of being disposed or accommodated in the notch or recess of the blade when the blade is in its open state; and a rotation mechanism that connects the handle, the blade, and the movable piece to each other by a single rotating shaft portion allows the blade and the movable piece to rotate relative to the handle, and allows the movable piece to rotate relative to the blade only within a specific rotation angle, said rotation mechanism rotating the movable piece relative to the blade so that the protrusion is disposed or accommodated inside the notch or recess of the blade when the blade is in its open state, and so that the protrusion is disposed outside of the notch or recess of the blade when the blade is in its closed state.

Also, the folding knife according to the present invention may be configured such that the rotation mechanism comprises a stopper that is fixed or formed on a part of the handle side; a first stopper contact portion that is fixed or formed on the movable piece side, said first stopper contact portion hitting the stopper when the blade is in its closed state, thereby preventing rotation of the movable piece in the blade closing direction in which the blade rotates from its open state to its closed state, so that the protrusion is disposed outside of the notch or recess of the blade; and a second stopper contact portion that is fixed or formed on the movable piece side, said second stopper contact portion hitting the stopper when the blade is in its open state, thereby preventing rotation of the movable piece in the blade opening direction in which the blade rotates from its closed state to its open state, so that the protrusion is disposed or accommodated inside the notch or recess of the blade.

Also, the folding knife according to the present invention may be configured such that the notch or recess is formed in the blade at a position near the rotating shaft portion and at a position on the opposite side from the cutting edge, and the protrusion is formed in a shape corresponding to the notch or recess.

Also, the folding knife according to the present invention may be configured such that when the blade is in its closed state, the protrusion is disposed at a position away from the notch or recess of the blade by a specific angle in the blade opening direction in which the blade rotates from its closed state to its open state.

Also, the folding knife according to the present invention may be configured as a folding knife in which a blade and a handle are rotatably connected to each other so as to be able to transition between a closed state, in which the blade is disposed or accommodated in the handle, and an open state, in which the blade is fully open from the handle, and when the closed knife is taken out of a specific holster or a garment pocket, the blade comes out of the handle and is open as a result of a protrusion on the blade side catching on a part of the holster or pocket, said folding knife comprising a notch or recess formed at a position on the opposite side from the cutting edge of the blade; a movable piece that is rotatably connected not only with respect to the handle but also partially with respect to the blade; a protrusion in the movable piece, said protrusion being formed in the movable piece so that when the blade is in its closed state, the protrusion is disposed at a position facing the notch or recess and at a position away from the notch or recess by a specific angle in the blade opening direction in which the blade rotates from its closed state to its open state, and is formed in a shape corresponding to the notch or recess; and a rotation mechanism that rotates the movable piece while partially rotating in conjunction with the blade, wherein the rotation mechanism is such that (a) in a closed state in which the blade is disposed in the handle, a protrusion formed on the movable piece is disposed and held at a position away from the notch or recess formed on the back side of the blade near the rotating shaft portion by a specific rotation angle in the blade opening direction in which the blade rotates from its closed state to its open state, (b) while the blade is in the course of transitioning from its closed state to its open state, or while the blade is in the course of transitioning from its open state to its closed state, the movable piece is able to rotate with respect to the blade within a specific rotation angle and is rotated with respect to the handle together with the blade outside the specific rotation angle, and (c) in its open state in which the blade is fully opened from the handle, a protrusion of the movable piece is disposed or accommodated in the notch or recess of the blade.

### Effects of the Invention

In the present invention, a rotation mechanism is provided so that the blade and the movable piece are able to rotate relative to the handle, and so that the movable piece is able to rotate relative to the blade by a specific rotation angle, and this rotation mechanism allows the movable piece to rotate relative to the blade within a specific rotation angle so that the protrusion is disposed or accommodated inside the notch or recess of the blade in its open state, and the protrusion is disposed outside of the notch or recess of the blade in its closed state. Consequently, with the present invention, in its open state when the blade is fully opened from the handle, the protrusion of the movable piece can be disposed or accommodated inside the notch or recess of the blade, so when the user puts his thumb on the back side of the blade with the blade open and tries to push the knife down from above, the problem that occurred with a conventional folding knife, in which the protrusion on the blade side ended up hitting the user's thumb, can be effectively avoided.

Also, in the present invention, when there are provided on the movable piece side a first stopper contact portion that hits the stopper on the handle side and thereby prevents the movable piece from rotating in the blade closing direction so that the protrusion is disposed outside of the notch or recess of the blade when the blade is in its closed state, and a second stopper contact portion that hits the stopper on the handle side and thereby prevents the movable piece from rotating in the blade opening direction so that the protrusion is disposed or accommodated inside the notch or recess of the blade when the blade is in its open state, if the blade is in its closed state, the protrusion will be reliably disposed outside of the notch or recess of the blade, and if the blade is in its open state, the protrusion will be reliably disposed or accommodated inside the notch or recess of the blade.

Also, in the present invention, when the notch or recess is formed at a position in the blade that is near the rotating shaft portion and at a position on the opposite side from the cutting edge, and the protrusion is formed at a position in the movable piece that is facing the notch or recess and in a shape that corresponds to the notch or recess, then when the blade completes its transition from its closed state to its open state, the protrusion will be reliably disposed or accommodated inside the notch or recess.

Also, in the present invention, when the blade is in its closed state and the protrusion is disposed at a position away from the notch or recess of the blade by a specific angle in the opening direction, when the user removes the knife from a holster or a pocket, the protrusion will reliably catch on a part of the holster or the pocket, and as a result the blade will rotate so as to come out of the handle.

Furthermore, in the present invention, the rotation mechanism is such that (a) in a closed state in which the blade is disposed or accommodated in the handle, a protrusion formed on the movable piece is disposed and held at a position away from the notch or recess formed on the back side of the blade near the rotating shaft portion by a specific rotation angle in the blade opening direction, (b) in the course in which the blade is transitioning from its closed state to its open state, or in the course in which the blade is transitioning from its open state to its closed state, the movable piece is able to rotate with respect to the blade within a specific rotation angle, and is rotated with respect to the handle together with the blade outside the specific rotation angle, and (c) in its open state in which the blade is fully opened from the handle, a protrusion of the movable piece is disposed or accommodated in the notch of the blade.

Therefore, with the present invention, in its open state in which the blade is fully opened from the handle, the protrusion on the blade side will be disposed or accommodated inside the notch or recess of the blade. Consequently, with the present invention, the problem that occurred with a conventional folding knife, in which the protrusion on the back side of the blade ended up hitting the user's thumb when the user put his thumb on the blade and tried to push the blade down from above in its open state, can be effectively avoided.

### BRIEF DESCRIPTION OF DRAWINGS

FIG. 1 consists of diagrams illustrating the folding knife in its closed state according to Embodiment 1 of the present invention, where (a) is a schematic side view of the whole knife in Embodiment 1, (b) is a side view of the blade and the movable piece, and (c) is an oblique view of the blade and the movable piece;

FIG. 2A is a diagram illustrating the folding knife in the course of transitioning from its closed state to its open state according to Embodiment 1, and is a schematic side view showing the whole knife;

FIG. 2B consists of diagrams illustrating the folding knife in the course of transitioning from its closed state to its open state according to Embodiment 1, in which (a) is a side view of the blade and the movable piece, and (b) is an oblique view of the blade and the movable piece;

FIG. 3 consists of diagrams illustrating the folding knife in its open state according to Embodiment 1, in which (a) is a schematic side view of the whole knife in Embodiment 1, (b) is a side view of the blade and the movable piece, and (c) is an oblique view of the blade and the movable piece;

FIG. 4 is a schematic side view illustrating the folding knife in its open state according to Embodiment 2 of the present invention; and

FIG. 5 consists of diagrams of a conventional folding knife configured such that a protrusion is formed on a part of a blade, and when the knife is taken out of a holster or a pocket, the protrusion catches on a part of the holster or the pocket and the blade is automatically opened from the handle.

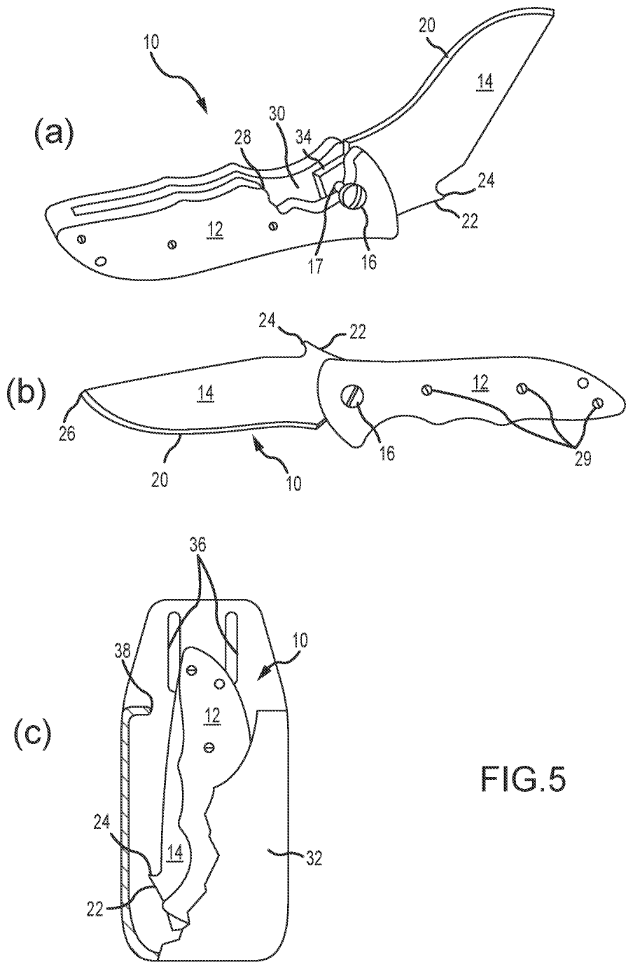

### DETAILED DESCRIPTION OF THE INVENTION

### First Embodiment

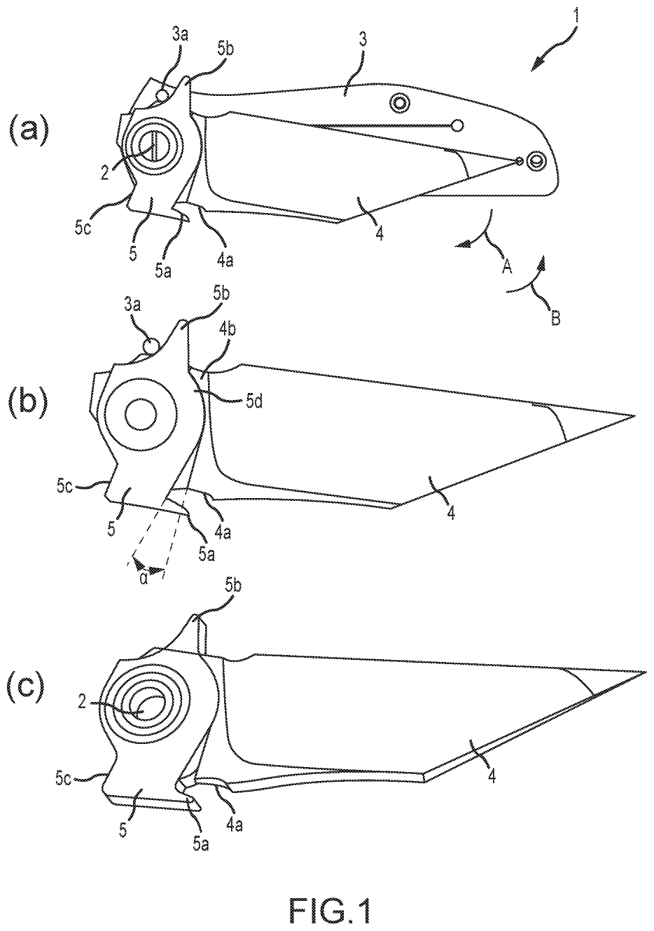

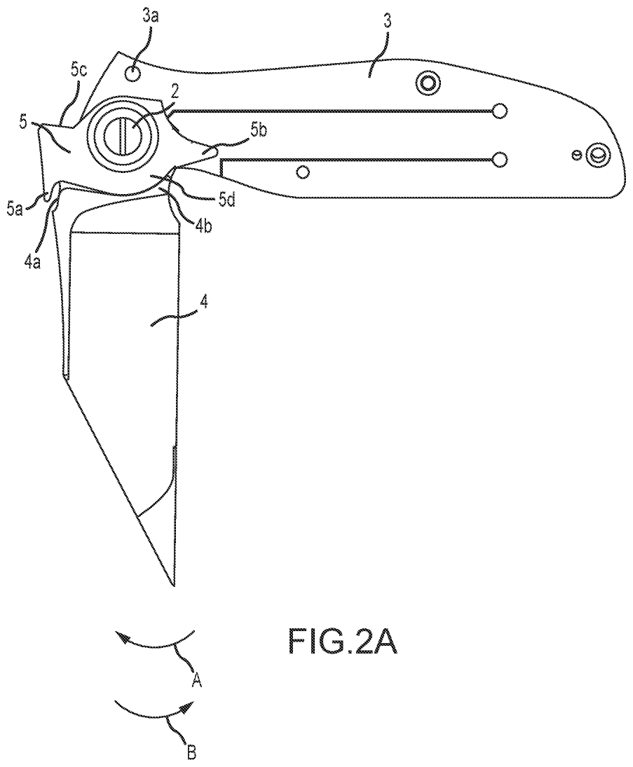

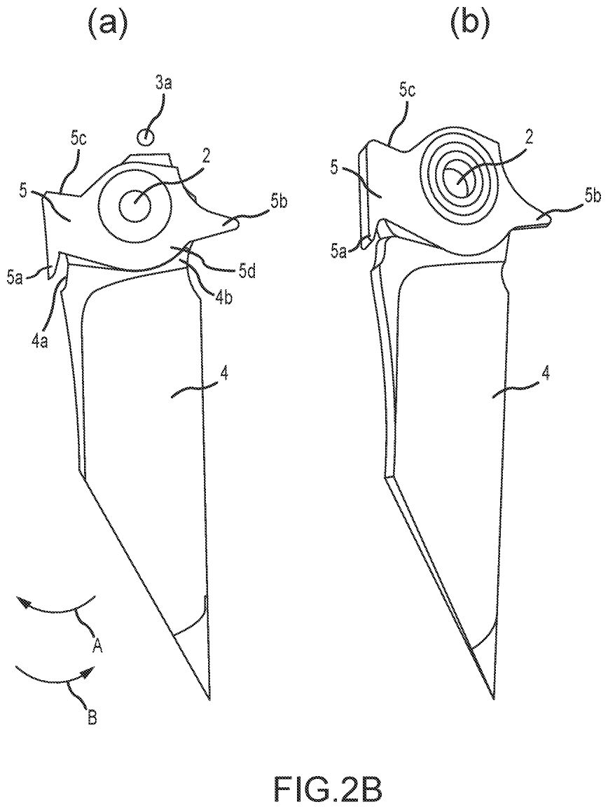

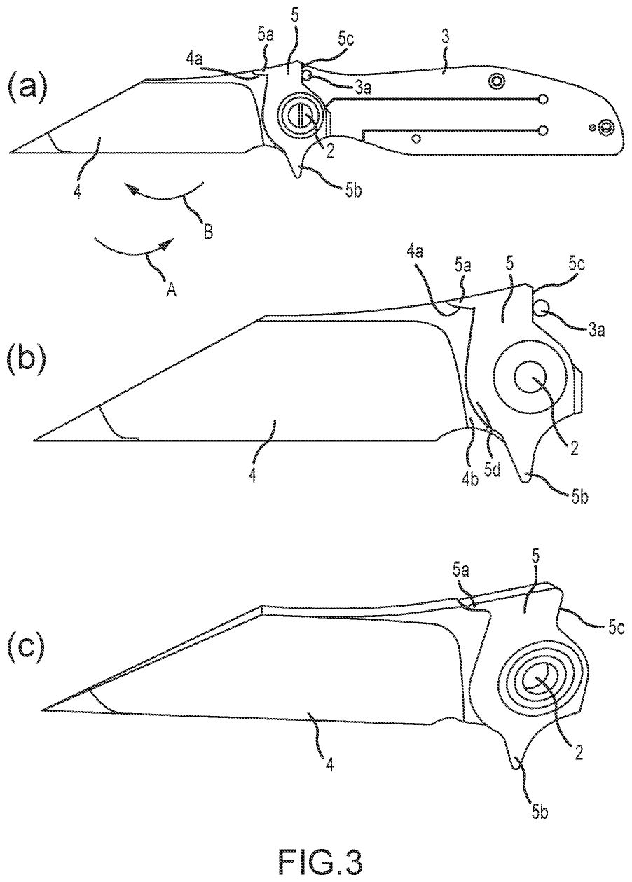

Embodiments of the present invention will now be described with reference to the drawings. FIG. 1 consists of diagrams illustrating the folding knife of Embodiment 1 in its closed state. FIGS. 2A and 2B are diagrams illustrating the folding knife of Embodiment 1 in the course of transitioning from its closed state to its open state. FIG. 3 consists of diagrams illustrating the folding knife of Embodiment 1 in its open state.

In FIGS. 1-3, 1 is a folding knife, 2 is a rotating shaft portion, 3 is a handle, 3a is a pin (stopper) provided at a position on the handle 3 near the rotating shaft portion 2, 4 is a blade connected to the handle 3 via the rotating shaft portion 2, 4a is a notch with a specific shape that is formed at a position on the blade 4 near the rotating shaft portion 2, and at a position on the opposite side from the cutting edge of the blade 4 (the back side), 4b (see FIG. 1 (b), etc.) is a curved surface portion of the blade 4 that is formed at a position on the cutting edge side of the blade 4 near the rotating shaft portion 2 and is formed in a curved surface shape that is concentric with the rotating shaft portion 2, 5 is a movable piece that is connected to the handle 3 and the blade 4 via the rotating shaft portion 2, 5a is a protrusion that is formed in a shape corresponding to the notch 4a (a shape that can be disposed or accommodated in the notch 4a) at a position facing the notch 4a in the movable piece 5, 5b is a protruding flip tab (first stopper contact portion) that is formed at a position on the movable piece 5 that is substantially on the opposite side from the protrusion 5a, 5c is a contact portion (second stopper contact portion) formed at a position on the movable piece 5 that is near the protrusion 5a in the blade opening direction (the arrow A direction in FIG. 1 (a)), and 5d is a curved surface portion on the movable piece 5 that is formed in a curved surface shape that can hit the curved surface portion of the blade 4 side.

In addition, in FIG. 1 (a), the handle 3 is shown so that the front side in the drawing is transparent, allowing the blade 4 and the movable piece 5 inside to be seen. That is, in its closed state, the blade 4 and the movable piece 5 are accommodated in a groove portion in the center of the handle 3 (see FIG. 6 (a)), but in FIG. 1 (a), we can see through the front side of the handle 3, allowing the blade 4 and the movable piece 5 accommodated inside the handle 3 to be visible.

In Embodiment 1, for example, the blade 4, which is formed by grinding down a stainless steel material, the movable piece 5, which is formed by grinding down a titanium alloy, and the handle 3, in which plastic covers are affixed to the outside of a liner formed by grinding down a titanium alloy, for example, are connected and linked by the rotating shaft portion 2 as shown in FIG. 1 (a).

Also, in Embodiment 1, the blade 4 is connected to the handle 3 via the rotating shaft portion 2 so as to be rotatable within a range of about 0 degrees to about 180 degrees with respect to the handle 3. The movable piece 5 is configured separately from the blade 4. The movable piece 5 is attached to the blade 4 and the handle 3 via the rotating shaft portion 2.

In Embodiment 1, as shown in FIG. 1, the flip tab 5b is disposed so as to be able to hit the pin 3a (stopper) on the handle side when the movable piece 5 rotates to the closed blade state. Also, as shown in FIG. 3, the contact portion 5c is disposed so as to be able to hit the pin 3a (stopper) on the handle side when the movable piece 5 rotates to the open blade state.

In Embodiment 1, as described above, the protrusion 5a in the movable piece 5 is formed at a position where it can be disposed or accommodated in the notch 4a in the blade 4, and so as to have a shape that can be disposed or accommodated in the notch 4a in the blade 4. Also, in Embodiment 1, the protrusion 5a is formed at a position away from the notch 4a of the blade 4 by a specific rotation angle (see a in FIG. 1 (a)) in its closed state shown in FIG. 1, in the blade opening direction (the direction of arrow A in FIGS. 2A and 2B).

In Embodiment 1, as shown in FIGS. 2A and 2B, the end portion of the movable piece 5 facing the back side of the blade 4, and the end portion on the back side of the blade 4 facing the movable piece 5 are facing each other with a slight gap (a substantially fan-shaped gap corresponding to the rotation angle indicated by a in FIG. 1 (b)). Consequently, the movable piece 5 and the blade 4 are configured to be able to rotate relative to each other only within the range of the above-mentioned gap, that is, within a specific rotation angle, such as 10 to 20 degrees (see a in FIG. 1 (b)).

In Embodiment 1, as shown in FIGS. 2A and 2B, outside the above-mentioned specific rotation angle, such as a rotation angle of 10 to 20 degrees (see a in FIG. 1 (b)), the curved surface portion 5d (a portion that is concentric with the rotating shaft portion 2) formed on the blade 4 side of the movable piece 5 hits the curved surface portion 4b (a portion that is concentric with the rotating shaft portion 2) on the movable piece 5 side of the blade 4. Consequently, in Embodiment 1, the movable piece 5 is linked to the blade 4 and rotates together with the blade 4 outside the above-mentioned specific rotation angle, such as a rotation angle of 10 to 20 degrees (see a in FIG. 1 (b)).

In Embodiment 1, the pin 3a (stopper) on the handle 3 side and the flip tab 5b (first stopper contact portion) on the movable piece 5 side serve to dispose the protrusion 5a outside of the notch 4a of the blade 4 and to protrude from the blade 4 (see FIG. 1) when the blade 4 transitions from its open state to its closed state and the flip tab 5b hits the pin 3a (the state shown in FIG. 1). That is, the pin 3a (stopper) on the handle 3 side and the flip tab 5b on the movable piece 5 side serve to create a state in which the protrusion 5a is disposed outside of the notch 4a of the blade 4 and protrudes from the blade 4 when the blade 4 has transitioned to its closed state, and also serve to prevent the protrusion 5a disposed outside of the notch 4a of the blade 4 from rotating in the blade closing direction (the direction of arrow B in FIG. 1) and from being accommodated in the notch 4a.

Also, in Embodiment 1, the pin 3a (stopper) on the handle 3 side and the contact portion 5c (second stopper contact portion) on the movable piece 5 side serve to dispose and accommodate the protrusion 5a in the notch 4a of the blade 4 when the blade 4 transitions from its closed state to its open state and the contact portion 5c hits the pin 3a (the state shown in FIG. 3). That is, the pin 3a (stopper) on the handle 3 side and the contact portion 5c on the movable piece 5 side serve to dispose and accommodate the protrusion 5a in the notch 4a of the blade 4 when the blade 4 transitions to its open state, and also serve to prevent the blade 4 and the movable piece 5, including the protrusion 5a, from rotating further in the blade opening direction (the arrow A direction in FIG. 3) than in its open state shown in FIG. 3 and going to the outside of the notch 4a.

Also, in Embodiment 1, when the blade 4 is neither in its open state nor in its closed state and is instead in the course of transitioning between these states, the movable piece 5 rotates in conjunction with the blade 4 (together with the blade 4) when rotated outside the range of a specific rotation angle (see a in FIG. 1 (b)), but is able to rotate freely with respect to the blade 4 when rotated within the range of said rotation angle (see a in FIG. 1 (b)).

The reason why the movable piece 5 rotates in conjunction with the movement of the blade 4 (together with the blade 4) when rotated outside the range of the specific rotation angle (see a in FIG. 1 (b)) is that, as shown in FIGS. 2A and 2B, outside the range of this rotation angle, the curved surface portion 5d of the movable piece 5 hits the curved surface portion 4b of the blade 4, and the movable piece 5 is linked to the blade 4. On the other hand, the reason why the movable piece 5 can rotate freely with respect to the blade 4 when the movable piece 5 rotates within the range of said rotation angle (see a in FIG. 1 (b)) is that, as shown in FIGS. 2A and 2B, the curved surface portion 5d (a portion that is concentric with the rotating shaft portion 2) of the movable piece 5 that hits the curved surface portion 4b (a portion that is concentric with the rotating shaft portion 2) on the blade 4 side is not formed at the portion of the movable piece 5 near the protrusion 5a, and a substantially fan-shaped gap is formed between the portion of the movable piece 5 near the protrusion 5a and the portion on the blade 4 side facing this protrusion 5a.

The operation of Embodiment 1 will now be described. In Embodiment 1, by having the rotating shaft portion 2, the pin 3a (stopper) formed on the handle 3, the flip tab 5b formed on the movable piece 5, the contact portion 5c formed on the movable piece 5, the curved surface portion 5d formed on the movable piece 5, and the curved surface portion 4b formed on the blade 4, a rotation mechanism portion is configured that allows the blade 4 and the movable piece 5 to rotate relative to the handle 3 as well as the movable piece 5 to rotate relative to the blade 4 only within a specific rotation angle (the angle indicated by a in FIG. 1 (b)). In Embodiment 1, the following operation is performed by this configuration.

First, the operation in its closed state in which the blade 4 is disposed or accommodated in the handle 3 will be described with reference to FIG. 1. At the stage where the transition from the open blade state to the closed blade state is complete, the blade 4 is disposed or accommodated in a state of having moved as much as possible toward the back of the inside of the handle 3. In this closed blade state, as shown in FIG. 1, the flip tab 5b on the movable piece 5 side hits the pin 3a (stopper) on the handle 3 side. Consequently, the movable piece 5 is prevented from rotating further in the blade closing direction (the direction of arrow B in FIG. 1 (a)) than its closed state shown in FIG. 1 with respect to the blade 4. Consequently, the protrusion 5a of the movable piece 5 is disposed and held outside of the notch 4a of the blade 4, that is, at a position away from the notch 4a of the blade 4 by a specific rotation angle (the rotation angle indicated by a in FIG. 1 (b)) in the blade opening direction (the direction of arrow A in FIG. 1 a)). Consequently, the protrusion 5a is in a state of protruding from the back side of the blade 4 (the opposite side from the cutting edge), so that when the user removes the knife from a pouch or pocket, the protrusion 5a will hit a part of the pouch or pocket and the blade 4 will rotate. In its closed state, the blade 4 is locked by a known means so as not to come out of the handle 3 easily.

Next, the operation of the blade 4 in the course of transitioning from its closed state to its open state will be described with reference to FIGS. 2A and 2B. As described above, outside of the specific rotation angle (the angle indicated by a in FIG. 1 (b)), the curved surface portion 5d on the movable piece 5 side hits the curved surface portion 4b on the blade 4 side, and as a result, the movable piece 5 and the blade 4 are linked to each other. Therefore, outside the specific rotation angle (the angle indicated by a in FIG. 1 (b)), the movable piece 5 will rotate with respect to the handle 3 together with the blade 4. Consequently, while the blade 4 is in the course of transitioning from its closed state to its open state, the movable piece 5 basically rotates in the blade opening direction (the direction of arrow A in FIGS. 2A and 2B) together with the blade 4 with respect to the handle 3 and transitions to its open state (discussed below) (see FIG. 3).

Next, the operation in its open state in which the blade 4 is fully opened from the handle 3 will be described with reference to FIG. 3. When the blade 4 transitions to its open state, the movable piece 5 and the blade 4 rotate together as much as possible in the blade opening direction (the direction of arrow A in FIG. 3 (a)). In the course of this, when the contact portion 5c of the movable piece 5 hits the pin 3a (stopper) of the handle 3, the movable piece 5 is prevented from rotating further in the blade opening direction than the state shown in FIG. 3. As a result, the protrusion 5a of the movable piece 5 is disposed and accommodated in the notch 4a of the blade 4. At the same time, the end portion of the movable piece 5 near the protrusion 5 and the end portion of the blade 4 near the protrusion 5 hit each other. As a result, the blade 4 is also prevented from rotating further in the blade opening direction than the state shown in FIG. 3 due to the presence of the contact portion 5c of the movable piece 5 and the pin 3a (stopper) of the handle 3. In its open state, the blade 4 is locked by a known means so as not to rotate easily in the direction of the handle 3 from the state of being fully opened from the handle 3 as shown in FIG. 3.

The operation of the blade 4 in the course of transitioning from its open state to its closed state will be described with reference to FIGS. 2A and 2B. As described above, the movable piece 5 is configured to be relatively rotatable with respect to the blade 4 within a specific rotation angle (the angle indicated by a in FIG. 1 (b)), but outside the range of the specific rotation angle (the angle indicated by a in FIG. 1 (b)), the movable piece 5 rotates together with the blade 4 with respect to the handle 3. Consequently, while the blade 4 is in the course of transitioning from its open state to its closed state, the movable piece 5 basically rotates along with the blade 4 with respect to the handle 3 in the blade closing direction (the direction of arrow B in FIGS. 2A and 2B) and transitions to the above-mentioned closed blade state (see FIG. 1).

As described above, in Embodiment 1, a rotation mechanism is provided that allows the blade 4 and the movable piece 5 to rotate relative to the handle 3, and that allows the movable piece 5 to rotate relative to the blade 4 only within the range of a specific rotation angle (see a in FIG. 1 (b)), the rotation mechanism allows the movable piece 5 to rotate relative to the blade 4 only within the range of a specific rotation angle α, so that in its open state the protrusion 5a will be disposed or accommodated inside the notch 4a of the blade 4, and in its closed state the protrusion 5a will be disposed outside of the notch 4a of the blade 4. Consequently, with Embodiment 1, in its open state in which the blade 4 is fully opened from the handle 3, the protrusion 5a of the movable piece 5 will be disposed or accommodated inside the notch 4a of the blade 4. Consequently, the problem that occurred with a conventional folding knife, in which the protrusion on the blade 4 side ended up hitting the user's thumb when the user put his thumb on the blade 4 and tried to push the blade 4 down from above in its open state, can be effectively avoided.

Also, in Embodiment 1, there are provided the flip tab 5b on the movable piece 5 side which prevents the movable piece 5 (the movable piece 5 disposed outside of the notch 4a of the blade 4) from rotating in the blade closing direction by hitting the pin 3a on the handle 3 side because when the blade 4 is in its closed state, the protrusion 5a is disposed outside of the notch 4a of the blade 4, as well as the contact portion 5c on the movable piece 5 side which prevents the movable piece 5 (the movable piece 5 disposed or accommodated inside the notch 4a of the blade 4) from rotating in the blade opening direction by hitting the pin 3a on the handle 3 side because when the blade 4 is in its open state, the protrusion 5a is disposed or accommodated inside the notch 4a of the blade 4. Consequently, with Embodiment 1, when the blade 4 is in its closed state, the protrusion 5a can be reliably disposed outside of the notch 4a of the blade 4, and when the blade 4 is in its open state, the protrusion 5a can be reliably disposed or accommodated inside the notch 4a of the blade 4.

Also, in Embodiment 1, the notch 4a is formed at a position on the blade 4 near the rotating shaft portion 2 and on the opposite side (back side) from the cutting edge, and the protrusion 5a is formed at a position on the movable piece 5 facing the notch 4a and in a shape corresponding to the notch 4a, so when the blade 4 has completed the transition from its closed state to its open state, the protrusion 5a is reliably disposed or accommodated inside the notch 4a.

Also, in Embodiment 1, the protrusion 5a is formed so that when the blade is in its closed state, the protrusion 5a is disposed at a position away from the notch 4a of the blade 4 of the movable piece 5 by a specific rotation angle α in the blade opening direction, so when the user removes the knife from a holster or pocket, the protrusion 5a reliably catches on a part of the holster or pocket, and as a result the blade 4 is reliably rotated so as to come out of the handle 3.

Furthermore, in Embodiment 1, the rotation mechanism is configured such that (a) when the blade 4 is in its closed state, the protrusion 5a on the movable piece 5 side is disposed and held at a position away from the notch 4 formed on the back side of the blade 4 near the rotating shaft portion by a specific rotation angle in the blade opening direction, (b) while the blade 4 is in the course of transitioning from its closed state to its open state, if the movable piece 5 is within the specific rotation angle, the movable piece 5 is able to rotate relative to the blade 4, and if the movable piece 5 is outside the specific rotation angle, the movable piece 5 is rotated with respect to the handle 3 together with the blade 4, (c) in its open state in which the blade 4 is fully opened from the handle 3, a protrusion 5a of the movable piece 5 is disposed or accommodated in the notch 4a of the blade 4, and (d) while the blade 4 is in the course of transitioning from its open state to its closed state, if the movable piece 5 is within the specific rotation angle, the movable piece 5 is able to rotate relative to the blade 4, and if the movable piece 5 is outside the specific rotation angle, the movable piece 5 is rotated with respect to the handle 3 together with the blade 4. Consequently, in Embodiment 1, in its open state in which the blade 4 is fully opened from the handle 3, the protrusion 5a on the blade 4 side will be disposed or accommodated inside the notch 4a of the blade 4, and the problem that occurred with a conventional folding knife, in which the protrusion on the blade 4 side ended up hitting the user's thumb, can be effectively avoided.

### Second Embodiment

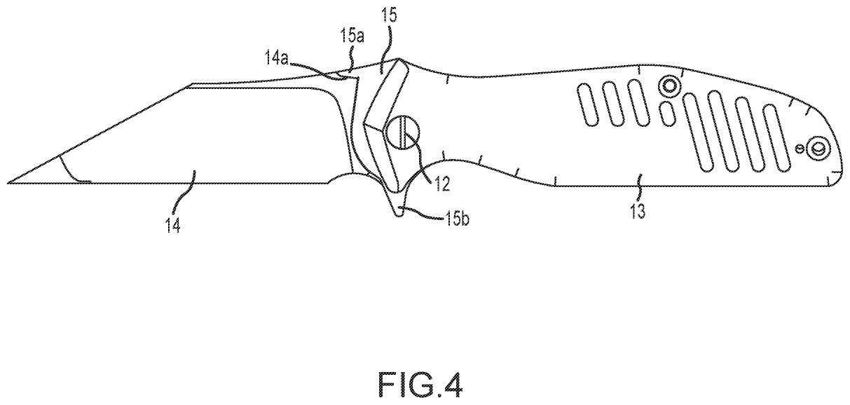

Embodiment 2 of the present invention will now be described with reference to FIG. 4. The basic configuration of Embodiment 2 is the same as that of Embodiment 1, so the following description will focus on the parts that are different.

In FIG. 4, 13 is a handle, 14 is a blade that is rotatably attached to the handle 3 via a rotating shaft portion 12, and 15 is a movable piece that is disposed between the handle 13 and the blade 14 and is connected to the handle 3 and the blade via the rotating shaft portion 12.

The movable piece 15 is configured to be rotatable with respect to the handle 13 within a range of about 0 degrees to about 180 degrees. Also, the movable piece 15 is configured to be relatively rotatable with respect to the blade 14 within the range of a specific rotation angle (see a in FIG. 1 (b)), and to rotate together with the blade 14 outside this range of angles.

Also, the protrusion 15a is formed at one end portion of the movable piece 5, and the flip tab 15b (which hits the stopper provided on the handle 3 side and prevents the movable piece 15 from rotating in the blade closing direction in its closed state) is formed at the other end portion.

As described above, the configuration in Embodiment 2 is basically the same as that in Embodiment 1. Consequently, the same action and effect as those described in Embodiment 1 above can also be obtained in this Embodiment 2.

Although Embodiments 1 and 2 of the present invention were described above, the present invention is not limited to what was described as Embodiments 1 and 2, and various improvements and modifications can be made. For instance, in Embodiment 1, the portion on the blade 4 where the protrusion 5a of the movable piece 5 is disposed and accommodated when the blade 4 is in its open state was called “the notch 4a,” but in the present invention, a “recessed portion” (concave portion) may be used instead of a “notch,” and the protrusion 5a may be disposed on this recessed portion.

### DESCRIPTION OF THE REFERENCE NUMERALS

1 knife
2, 12 rotating shaft portion
3, 13 handle
3a pin (stopper)
4, 14 blade
4b, 5d curved surface portion
5, 15 movable piece
5a, 15a protrusion
5b, 15b flip tab (first stopper contact portion)
5c contact portion (second stopper contact portion)

1. A folding knife in which a blade and a handle are rotatably connected to each other so as to be able to transition between a closed state, in which the blade is disposed or accommodated in the handle, and an open state, in which the blade is fully open from the handle, and when the closed knife is taken out of a specific holster or a garment pocket, the blade comes out of the handle and is opened as a result of a protrusion on the blade side catching on a part of the holster or pocket, said folding knife comprising:
a movable piece that is attached to the blade and the handle so as to be relatively rotatable within a specific rotation angle with the blade, and to rotate with respect to the handle together with the blade outside of the specific rotation angle;
a notch or a recess formed at a position near a rotating shaft portion on the back side of the blade;
a protrusion that is formed at a position on the movable piece and in a shape corresponding to the notch or recess of the blade, said protrusion being capable of being disposed or accommodated in the notch or recess of the blade when the blade is in its open state; and
a rotation mechanism that connects the handle, the blade, and the movable piece to each other by a single rotating shaft portion, allows the blade and the movable piece to rotate relative to the handle, and allows the movable piece to rotate relative to the blade only within a specific rotation angle, said rotation mechanism rotating the movable piece relative to the blade so that the protrusion is disposed or accommodated inside the notch or recess of the blade when the blade is in its open state, and so that the protrusion is disposed outside the notch or recess of the blade when the blade is in its closed state.

2. The folding knife according to claim 1, wherein the rotation mechanism comprises:
a stopper that is fixed or formed on a part of the handle side;
a first stopper contact portion that is fixed or formed on the movable piece side, said first stopper contact portion hitting the stopper when the blade is in its closed state, thereby preventing rotation of the movable piece in the blade closing direction in which the blade rotates from its open state to its closed state, so that the protrusion is disposed outside of the notch or recess of the blade; and
a second stopper contact portion that is fixed or formed on the movable piece side, said second stopper contact portion hitting the stopper when the blade is in its open state, thereby preventing rotation of the movable piece in the opening direction in which the blade rotates from its closed state to its open state, so that the protrusion is disposed or accommodated inside the notch or recess of the blade.

3. The folding knife according to claim 1 or 2, wherein the notch or recess is formed in the blade at a position near the rotating shaft portion and at a position on the opposite side from the cutting edge, and the protrusion is formed in a shape corresponding to the notch or recess.

4. The folding knife according to claim 1, 2, or 3, wherein when the blade is in its closed state, the protrusion is disposed at a position away from the notch or recess of the blade by a specific angle in the opening direction in which the blade rotates from its closed state to its open state.

5. A folding knife in which a blade and a handle are rotatably connected to each other so as to be able to transition between a closed state, in which the blade is disposed or accommodated in the handle, and an open state, in which the blade is fully open from the handle, and when the closed knife is taken out of a specific holster or a garment pocket, the blade comes out of the handle and is opened as a result of a protrusion on the blade side catching on a part of the holster or pocket, said folding knife comprising:
a notch or a recess formed at a position on the opposite side from the cutting edge of the blade;
a movable piece that is rotatably connected not only with respect to the handle but also partially with respect to the blade;
a protrusion in the movable piece, said protrusion being formed in the movable piece so that when the blade is in its closed state, the protrusion is disposed at a position facing the notch or recess and at a position away from the notch or recess by a specific angle in the opening direction in which the blade rotates from its closed state to its open state, and is formed in a shape corresponding to the notch or recess; and
a rotation mechanism that rotates the movable piece while partially rotating in conjunction with the blade,
wherein the rotation mechanism is such that (a) in a closed state in which the blade is disposed in the handle, a protrusion formed on the movable piece is disposed and held at a position away from the notch or recess formed on the back side of the blade near the rotating shaft portion by a specific rotation angle in the blade opening direction in which the blade rotates from its closed state to its open state (b) while the blade is in the course of transitioning from its closed state to its open state, or while the blade is in the course of transitioning from its open state to its closed state, the movable piece is able to rotate with respect to the blade within a specific rotation angle, and is rotated with respect to the handle together with the blade outside the specific rotation angle, and (c) in its open state in which the blade is fully opened from the handle, a protrusion of the movable piece is disposed or accommodated in the notch or recess of the blade.
